(19) United States
(12) Patent Application Publication
(10) Pub. No.: US 2026/0104246 A1
(43) Pub. Date: Apr. 16, 2026

(54) Polarization-sensitive probe for low coherence interferometer system

(71) Applicant: Wojciech Jan Walecki, Sunrise, FL (US)

(72) Inventor: Wojciech Jan Walecki, Sunrise, FL (US)

(21) Appl. No.: 18/911,328

(22) Filed: Oct. 10, 2024

(51) Int. Cl. G01B 9/02091; G01B 9/02001

(52) U.S. Cl. CPC G01B 9/02091; G01B 9/02001

(57) ABSTRACT

The invention describes a novel optical coherence tomography probe allowing polarization control of the beam impinging and polarization analysis of the beam reflected from the sample, allowing polarization characterization of the reflectance of the measured sample.

### DESCRIPTION OF THE DRAWING

FIG. 1 represents the prior art OCT probe attached to the system for measuring the semiconductor wafer. Optical Beam emitted by low coherence broadband light source 101 is transmitted by single mode fiber 104 and is transmitted to circulator 103. The optical beam emerges from the circulator and is transmitted through single-mode fiber 106 to optical port 107 in the optical probe 100. Free space optical beam 108 emerges from port 107 and is collimated by optical lens 110 and forms a collimated beam 111. The collimated beam 111 is split by beamsplitter 113 into two beams: the reference beam 114 directed to reflector 115, and sample beam 117. The sample beam passes through the beam forming element 118 and exits optical probe 100 as the optical beam 119. The beam 119 is reflected from the sample transmitted back through the element 118, the beamsplitter 113, refocused by the lens 110 into the coupler 107 and the single mode optical fiber 106, and is directed to the optical circulator 103. The optical beam emerges from the circulator 103 through the fiber 105 and is analyzed by a spectrometer 102 connected by harness 192 controlled by the computed system 191. Computer 191 is connected using harness 193 to light source 101 which it controls.

FIG. 2 represents the novel invented probe for the measurement of surfaces. Broad spectrum beam is emitted by light source 201 and is transmitted through single mode fiber 204 to optical port 207. The divergent optical beam emitted from the entrance port 207 is collimated by lens 210, and collimated beam 216 passes through the entrance polarization device 250, exits the entrance polarization device 250, and forms an optical beam entering beam splitter 213. The collimated beam 216 is split by beamsplitter 213 into two beams: the reference beam 214 directed to reflector 215, and sample beam 217. The sample beam passes through the beam forming element 218 exits optical probe 200 and forms the optical beam 219. The optical beam 219 is reflected from sample 300 and later is transmitted back through element 218 to beamsplitter 213. The beamsplitter 213 reflects the portion of the beam towards the exit polarization device 251. The beam 212 emerging from the exit polarization device 251 is focused on fiber port 208 attached to single-mode fiber 205 which transmits radiation to computer-controlled spectrometer 202.

FIG. 3 represents the novel invented probe for the measurement of surfaces. Broad spectrum beam is emitted by light source 201 and is transmitted through single mode fiber 204 to optical port 207. The divergent optical beam emitted from the entrance port 207 is collimated by lens 210, and collimated beam 216 passes through the entrance polarization device 250, exits the entrance polarization device 250, and forms an optical beam entering beam splitter 213. The collimated beam 216 is split by beamsplitter 213 into two beams: the reference beam 214 directed to reflector 215, and sample beam 217. The sample beam passes through the beam forming element 218 exits optical probe 200 and forms the optical beam 219. The optical beam 219 is reflected from sample 300 and later is transmitted back through element 218 to beamsplitter 213. The beamsplitter 213 reflects the portion of the beam towards the exit polarization device 251. The beam 212 emerging from the exit polarization device 251 is focused on fiber port 208 attached to single-mode fiber 205 which transmits radiation to computer-controlled spectrometer 202. Computer 192 controls the light source 201 and is connected to it through harness 292. The computer 192 controls the spectrometer 221 and is connected to it through harness 293. Computer 192 controls the entrance polarization device 250. Computer 192 is connected to polarization device 250 through harness 294. Finally, the computer 192 controls the exit polarization device 251 and is connected to it through harness 295.

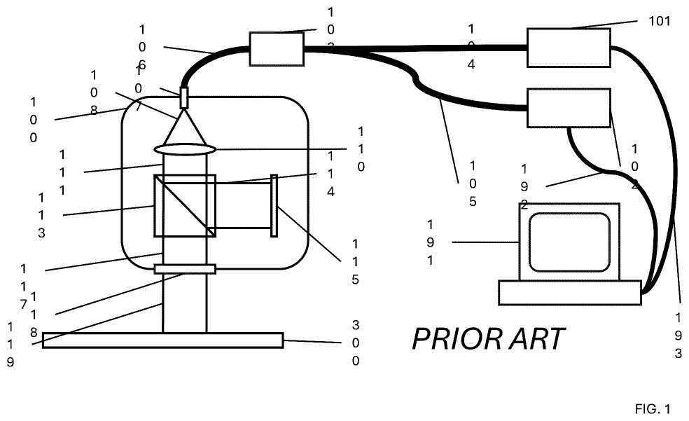

Optical coherence tomography (OCT) has been used to measure the topography and thickness of various semiconductor structures (see, for example, Walecki, Wojciech Jan. “Wafer thickness, topography, and layer thickness metrology system.” U.S. Pat. No. 11,885,609, issued Jan. 30, 2024.). FIG. 1 presents the typical optical probe and system for OCT measurement. It enables measuring the reflection of infrared radiation from the sample. The probe shown in FIG. 1 does not allow the user to analyze polarization changes of the reflected beam. The probe system shown in FIG. 1 can measure the thickness of transparent wafers and individual layers as described in U.S. Pat. No. 11,885,609.

The prior art optical probe shown in FIG. 1 measures the optical thickness of wafers and layers. The optical thickness is a product of the thickness of the wafer and of the refractive index of the wafer material. The probe shown in FIG. 1 provides accurate measurements only when the refractive index is isotropic and polarization-independent.

The system and probe shown in FIG. 1 may not provide accurate results for the anisotropic materials. For example, when measuring an anisotropic material characterized by two different values of the refractive index nₓ and n_{y} in the two perpendicular directions x and y in xy plane of the wafer value of the thickness of the material measured by a single probe will depend on the state of polarization of the impinging radiation.

The changes in the polarization state of the reflected beam contain important information about the anisotropic properties of the measured surface of the wafer. For the anisotropic materials often encountered in optoelectronic and piezoelectric structures the knowledge of the polarization states of the impinging and reflected beams is important for the precise measurements of the thickness of such structures, or the thickness of individual layers comprising measured structure.

Furthermore, isotropic materials sometimes become anisotropic due to mechanical stress or the electric field present in the material. The measurements of the polarization-dependent reflectivity can provide valuable information about stress.

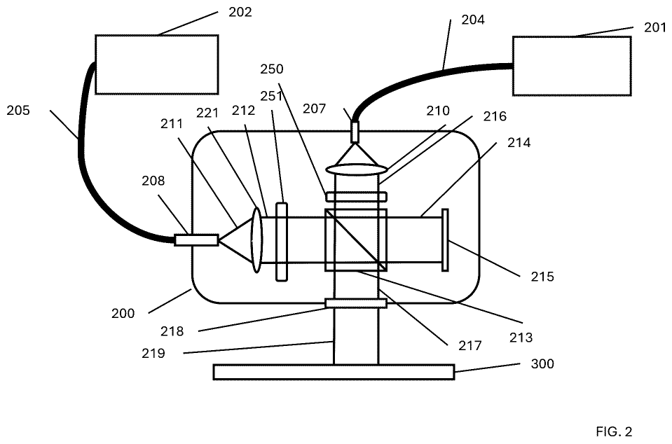

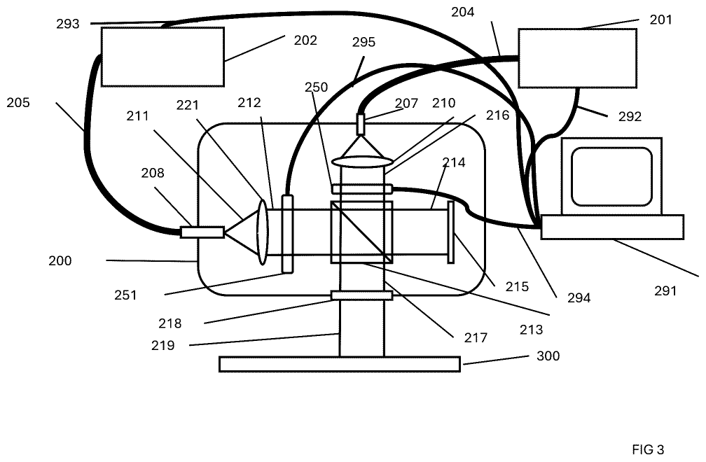

We present a novel probe that enables control of the polarization state of the impinging radiation using the entrance polarization device. The probe is equipped with an exit polarization device acting as an analyzer analyzing the polarization state of the reflected radiation. The novel device is presented in FIG. 2 and FIG. 3.

The exit and the input polarization devices can be simple linear or circular polarizers or more complex multi-component polarization control systems comprising polarizers and quarter and half waveplates. These systems may be implemented as systems comprising fiber optic components (see Poole, Simon B., J. E. Townsend, David N. Payne, Martin E. Fermann, G. J. Cowle, Richard I. Laming, and P. R. Morkel. “Characterization of special fibers and fiber devices.” Journal of lightwave technology 7, no. 8 (1989): 1242-1255 ), or system comprising free space components (Azzam, R. M. A., and N. M. Bashara. “Ellipsometric measurement of the polarization transfer function of an optical system.” JOSA 62, no. 3 (1972): 336-340 or “Ellipsometry and Polarized Light Hardcover”, North-Holland (Jan. 1, 1977), by N. M. Bashara and R. M. A. Azzam) or a combination of free space and fiber optic components.

The exit and the input polarization devices shown in FIG. 2 may or may not be controlled by the computer system as shown in FIG. 2 and FIG. 3.

1. The optical coherence tomography system's optical probe comprises two distinct optical ports: the entrance port and the exit port.

2. Optical probe as described in claim 1 where optical polarization controller is placed between the entrance port and optical beam splitter.

3. Optical probe as described in claim 1 where optical polarization controller is placed between the exit port and optical beam splitter.

4. Optical probe as described in claim 1 where the entrance optical polarization controller is placed between the entrance port and optical beam splitter and exit optical polarization controller is placed between the exit port and optical beam splitter.

5. Optical probe as described in claim 2 where the polarization controller is a simple polarizer.

6. Optical probe as described in claim 2 where the polarization controller controls all polarization parameters of the transmitted radiation.

7. Optical probe as described in claim 3 where the polarization controller is a simple polarizer.

8. Optical probe as described in claim 3 where the polarization controller controls all polarization parameters of the transmitted radiation.

9. Optical probe as described in claim 4 where the polarization controllers are simple polarizers.

10. Optical probe as described in claim 4 where the polarization controller controls all polarization parameters of the transmitted radiation.
